(19) United States
(12) Patent Application Publication
(10) Pub. No.: US 2017/0336982 A1
(43) Pub. Date: Nov. 23, 2017

(54) SYSTEM AND METHODOLOGY FOR AUTOMATICALLY DETERMINING AND IMPLEMENTING OPTIMIZED DATA REPLICATION ACROSS CLOUD STORAGE NODES

(71) Applicant: Knight Point Systems, Inc., Reston, VA (US)

(72) Inventors: Roy Keene, Reston, VA (US); Kenneth Van Alstyne, Reston, VA (US)

(73) Assignee: Knight Point Systems, Inc., Reston, VA (US)

(21) Appl. No.: 15/493,277

(22) Filed: Apr. 21, 2017

Related U.S. Application Data
(60) Provisional application No. 62/326,105, filed on Apr. 22, 2016.

(51) Int. Cl. G06F 3/06; G06F 11/20; G06F 17/30

(52) U.S. Cl. CPC G06F 3/065; G06F 11/2076; G06F 3/067; G06F 17/30233

(57) ABSTRACT

A system and method for implementing optimized data replication across cloud storage nodes, the system comprising a cluster of computer system devices. The system comprises one or more memory devices and a plurality of processors. The one or more memory devices, stores a set of program modules. A processor among the plurality of processor executes the set of program modules. The set of program modules comprises an input module and a data transfer module. The input module receives a first instruction to add a first computer system device to the cluster, wherein the first computer system device comprises a first memory device. The data transfer module copies data in at least one memory device in the cluster of computer system devices, to the first memory device, based on number of computer system devices in the cluster being lesser than a predefined number.

### CROSS REFERENCE TO APPLICATION

This patent application claims the benefit of U.S. Provisional Application No. 62/326,105 filed on Apr. 22, 2016. The above application is incorporated by reference herein in its entirety.

### FIELD OF THE INVENTION

The present invention relates generally to a system and method for automatically determining and implementing optimized data replication across cloud storage nodes, and more particularly, to a system and method by which data can be replicated automatically by cloud nodes to other cloud nodes when such are added but only in so far as such optimizes use of the cloud resources to minimize over-redundancy.

### BACKGROUND OF THE INVENTION

Cluster of computer systems refer to a group of computing devices interconnected via a communications network. As such, cluster computer systems act effectively as a single system with each computer system of the cluster of computer systems assigned tasks, which are scheduled by a software. Cluster computer systems are autonomous systems, but they need to all act together to achieve a common unified goal. Normally cluster sizes are planned, and therefore mirroring is done manually by administrators. Once set up, this will not change until additional manual changes are made. However, in a cluster of an unknown size, there is a need to automatically configure for how the cluster is “right now”, optimizing for whatever it has (it can't be known by the system whether cross-node redundancy will become available, or if inter-node redundancy is optimal), without manual intervention.

Hence, there is a need for a system and method, for automatically determining and implementing optimized data replication across cloud storage nodes

### SUMMARY OF THE INVENTION

The present invention relates to a system and method for implementing optimized data replication across cloud storage nodes.

In one embodiment of the present invention, a system for implementing optimized data replication across cloud storage nodes comprises a cluster of computer system devices. The cluster comprising one or more memory devices and a plurality of processors. The one or more memory devices is comprised in one or more computer system devices of the cluster of computer system devices. Each memory device among the one or more memory devices stores a set of program modules. A processor among the plurality of processor is comprised in a computer system device of the cluster of computer system devices. At least one processor executes the set of program modules. The set of program module comprises an input module and a data transfer module. The input module, executed by the at least one processor, is configured to receive a first instruction to add a first computer system device to the cluster.

The first computer system device comprises a first memory device. The data transfer module, executed by the processor, is configured to copy data in at least one memory device in the cluster of computer system devices, to the first memory device, based on number of computer system devices in the cluster being lesser than a predefined number.

In one embodiment of the present invention, the input module receives the first instruction from at least one of a user and at least one computer system device in the cluster. The data in the at least one memory device is at least one of images, videos, documents, computer instructions, and databases. Each computer system device in the cluster of computer system device is at least one of a laptop, a server, a network hardware device, a personal computer, and a smart phone, or any combination thereof. Each computer system device in the cluster of computer system device is connected to each other via a network. The network is at least one of Bluetooth, WI-FI, mobile networks, and a WiMax network. The network can also be a wired copper or fiber network as well (e.g., ethernet).

In one embodiment of the present invention, a method of implementing optimized data replication across cloud storage nodes comprises receiving by at least one processor via an input module, a first instruction to add a first computer system device to the cluster, wherein the first computer system device comprises a first memory device. Further, the method comprises copying by the at least one processor via a data transfer module, data in at least one memory device in the cluster of computer system devices, to the first memory device, based on number of computer system devices in the cluster being lesser than a predefined number.

Data loss across the cloud is a major concern. Worse yet, as storage nodes grow, the amount of potential for lost data grows as well. Storage cluster nodes can then grow to sizes wherein administrators do not know or comprehend how much potential data loss there can be CLOUDSEED™, however, is able to determine the storage cluster size at any given time. When a cluster is first instantiated as a single storage node, the minimum number of disks to automatically create the initial storage cluster redundancy is two, in order to internally mirror the disks in order to provide some amount of optimal redundancy of the data. The optimal mirror configuration is determined based on the number of nodes and/or disks, as the case may be. When the second node joins the cluster, the disks are still mirrored because the minimum number of nodes to reach a desired replication level of three, is three. When the third node joins the cluster, each node is treated as a single unit, as redundancy is guaranteed with the other nodes in the cluster. At the same time, the mirror configuration is broken apart on the first two nodes and all disks function as single units.

### BRIEF DESCRIPTION OF DRAWINGS

FIG. 1 illustrates a block diagram of an environment implemented in accordance with various embodiments of the invention.

FIG. 2 illustrates a block diagram of a system for implementing optimized data replication across cloud storage nodes in accordance with various embodiments of the invention.

FIG. 3 illustrates a flowchart of a computer implemented method of implementing optimized data replication across cloud storage nodes in accordance with various embodiments of the invention.

FIG. 4 illustrates a schematic diagram for a system and method by which data is “mirrored” (replicated) in a one node cloud system, according to an embodiment of the present invention.

FIG. 5 illustrates a schematic diagram for a system and method by which data is “mirrored” (replicated) in a two node cloud system, according to an embodiment of the present invention.

FIG. 6 illustrates a schematic diagram for a system and method by which data is “mirrored” (replicated) in a three or more node cloud system, according to an embodiment of the present invention.

### DETAILED DESCRIPTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

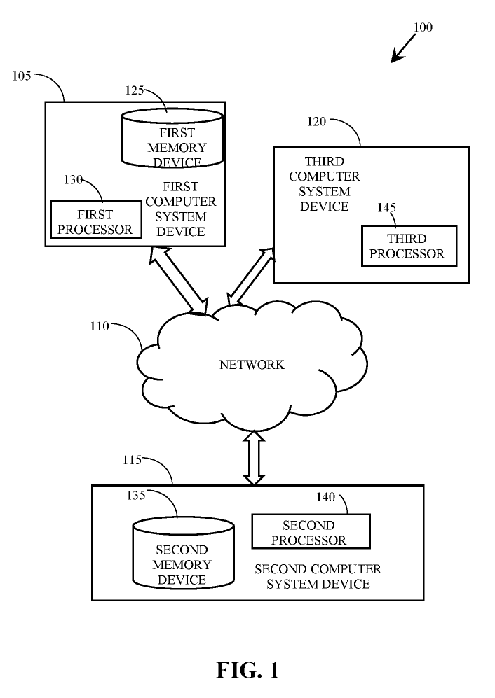

FIG. 1 is a block diagram of an environment 100 in accordance with which various embodiments of the present invention are implemented. The environment 100 comprises a first computer system device 105, a second computer system device 115 and a third computer system device 120. In one example, the first computer system device 105, the second computer system device 115, and the third computer system device 120 are connected as a computer cluster. The first computer system device 105, the second computer system device 115, and the third computer system device 120 are at least one of a laptop, a personal computer, a server, a smart phone, a network hardware device, and a smart television. The network hardware device is at least one of a gateway, a router, a network bridge, a modem, a wireless access point, and a network switch. In another example, the first computer system device 105, the second computer system device 115, and the third computer system device 120 are gateways to at least one of a wide area network, a local area network, and internet. The first computer system device 105, the second computer system device 115, and the third computer system device 120 are connected via a network 110. The network 110 is at least one of a mobile network, a wide area network, a local area network, and internet. The first computer system device 105 comprises a first memory device 125 and a first processor 130. The second computer system device 115 comprises a second memory device 135, and a second processor 140. The third computer system device 120 comprises a third processor 145. In one embodiment of the present invention, the computer cluster comprising the first computer system device 105, the second computer system device 115, and the third computer system device 120 hosts a system for patching software in a target computer system device. In one example, the target computer system device is at least one of the first computer system device 105, the second computer system device 115, and the third computer system device 120.

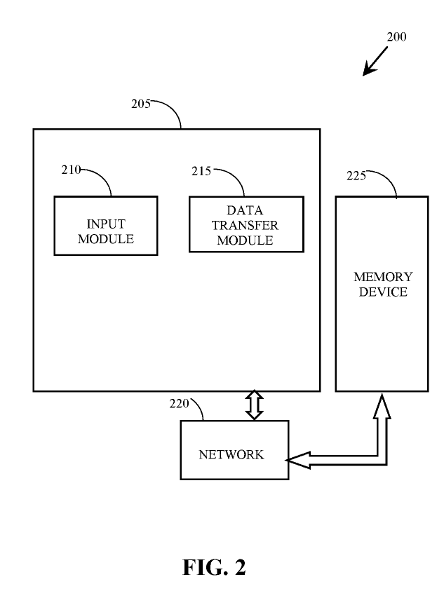

At least one of the first memory device 125 and the second memory device 135 stores a set of program modules. The set of program modules comprises an input module and a data transfer module. At least one processor among the first processor 130, the second processor 140, and the third processor 145 executes the set of program modules. The at least one processor executes the set of program modules. In one example, the set of program modules are executed by a combination of multiple processors among the first processor 130, the second processor 140, and the third processor 145. FIG. 2 is a block diagram of a system for implementing optimized data replication across cloud storage nodes according to one example of functioning of the present invention.

Referring to FIG. 2, in one example, a memory device 225 stores a set of program modules. In one embodiment of the present invention, a system for implementing optimized data replication across cloud storage nodes comprises a cluster of computer system devices. A processor 205 among the plurality of processor is comprised in a computer system device of the cluster of computer system devices. The processor 205 executes the set of program modules. The set of program module comprises an input module 210 and a data transfer module 215. The input module 210, executed by the at least one processor, is configured to receive a first instruction to add a first computer system device to the cluster.

The first computer system device comprises a first memory device. The data transfer module 215, executed by the processor 205, is configured to copy data in at least one memory device in the cluster of computer system devices, to the first memory device, based on number of computer system devices in the cluster being lesser than a predefined number.

In one embodiment of the present invention, the input module 210 receives the first instruction from at least one of a user and at least one computer system device in the cluster. The data in the at least one memory device is at least one of images, videos, documents, computer instructions, and databases. Each computer system device in the cluster of computer system device is at least one of a laptop, a server, a network hardware device, a personal computer, and a smart phone, or any combination thereof. Each computer system device in the cluster of computer system device is connected to each other via a network 220. The network 220 is at least one of Bluetooth, WI-FI, mobile networks, and a WiMax network. The network can also be a wired copper or fiber network as well (e.g., ethernet).

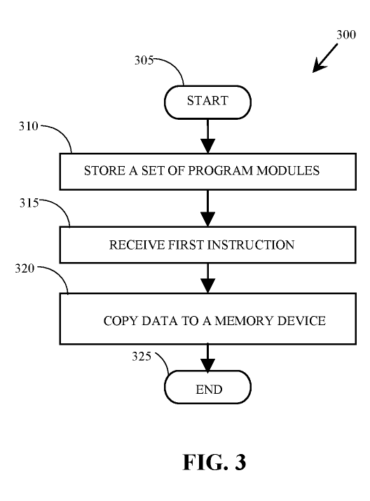

FIG. 3 is a flowchart of a computer implemented method 300 of implementing optimized data replication across cloud storage nodes in accordance with various embodiments of the invention. The method 300 is incorporated in an environment. The environment comprises a first computer system device, a second computer system device and a third computer system device. In one example, the first computer system device, the second computer system device, and the third computer system device are connected as a computer cluster. The first computer system device, the second computer system device, and the third computer system device are at least one of a laptop, a personal computer, a server, a smart phone, a network hardware device, and a smart television. The network hardware device is at least one of a gateway, a router, a network bridge, a modem, a wireless access point, and a network switch. In another example, the first computer system device, the second computer system device, and the third computer system device are gateways to at least one of a wide area network, a local area network, and internet. The first computer system device, the second computer system device, and the third computer system device are connected via a network. The network is at least one of a mobile network, a wide area network, a local area network, and internet. The first computer system device comprises a first memory device and a first processor. The second computer system device comprises a second memory device, and the second processor. The third computer system device comprises the third processor. In one embodiment of the present invention, the computer cluster comprising the first computer system device, the second computer system device, and the third computer system device hosts a system for patching software in a target computer system device. In one example, the target computer system device is at least one of the first computer system device, the second computer system device, and the third computer system device. At least one of the first memory device and the second memory device stores a set of program modules. The method 300 commences at step 305.

At step 310, each of the first memory device and the second memory device stores a set of program modules comprising an input module, and a data transfer module. At least one processor among the first processor, the second processor, and the third processor executes the set of program modules.

At step 315, an input module, executed by the processor receives via an input module, a first instruction to add a first computer system device to the cluster, wherein the first computer system device comprises a first memory device.

At step 320, a data transfer module executed by the processor copies data in at least one memory device in the cluster of computer system devices, to the first memory device, based on number of computer system devices in the cluster being lesser than a predefined number.

The method 300 ends at step 325.

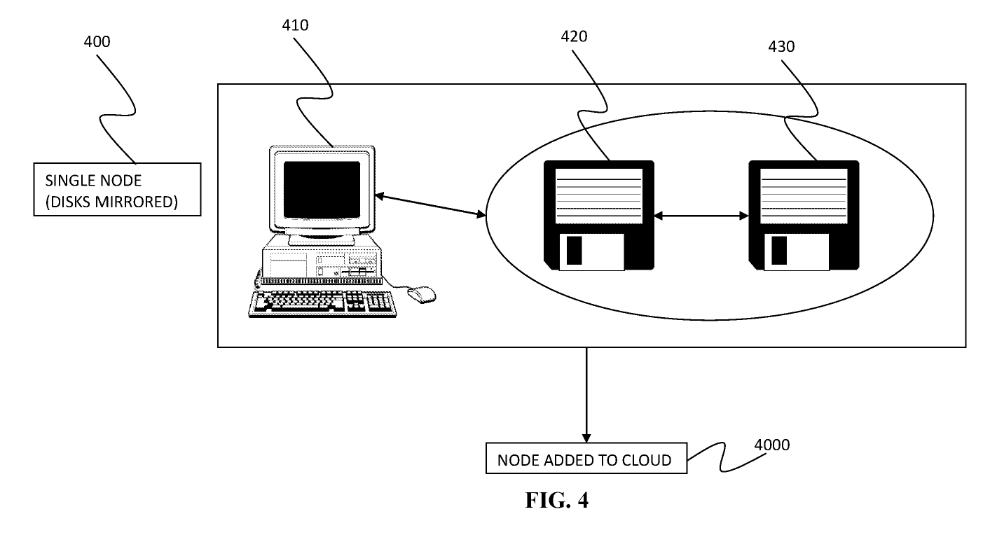

In one example, FIGS. 4, 5 and 6 illustrate a system and method that automatically determines and implements optimized data replication across cloud storage nodes. Such system and method allows for the optimization of data replication across cloud data storage nodes, whether such system is comprised of one, two, or three or more computer storage nodes. The CLOUDSEED™ system automatically recognizes when a new node is added to the storage cluster.

Such optimization is accomplished as each node initially replicates data on itself when the cluster is deemed of insufficient size. When a node is added, as is the case when a single node cluster becomes a two node cluster, data is replicated as between the node, which data is then self-replicated internally to the node. When a third node is added, data is replicated to the third node.

Referring now specifically to FIG. 4, a schematic diagram of a one node system 400 comprising a computer storage node 410 is shown. Computer storage node 410 has two storage disks 420 and 430. Such is the case because when a storage cluster is first created as a single storage node, the minimum number of disks to automatically create the initial storage cluster redundancy is two, in order to internally mirror the disks in order to provide some amount of optimal redundancy of the data. It is to be understood, however, that the optimal mirror configuration of a single node is based upon the number of available disks. Accordingly, in computer storage node 410 of cluster storage node 400, data is replicated as between storage disks 420 and 430.

At some point in time, additional storage nodes are likely to be added to the cluster. Accordingly, in step 4000, a storage node is added to the cloud cluster. Step 4000 is the same in each of FIGS. 4, 5 and 6 as a storage node may be added to the system at any time. CLOUDSEED™ either directs the storage nodes to select two other nodes for data replication, or such nodes are capable of random selection.

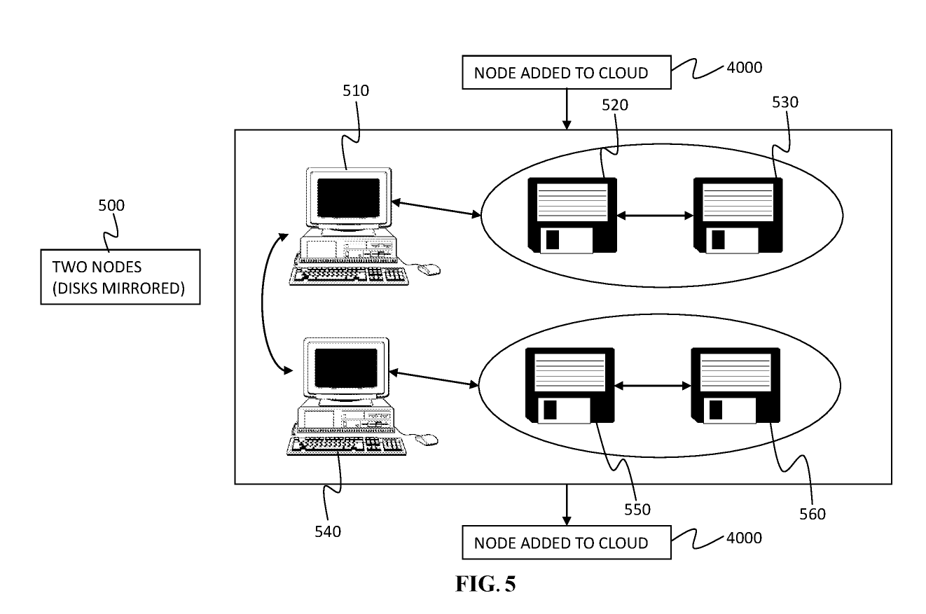

Referring now specifically to FIG. 5, a schematic diagram of a two node system 500 comprising computer storage nodes 510 and 540 is shown. Computer storage node 510 has two storage disks 520 and 530, while computer storage node 540 also has two storage disks 550 and 560. Like the single node 410 in the one node system 400, data is replicated as between the disks internal to the node. In other words data on storage disk 520 is replicated on storage disk 530. Additionally, however, data from computer storage node 501 is replicated to computer storage node 540, and vice versa for redundancy. This is because when the second node joins the cluster as in step 4000, the disks are still mirrored internally because the minimum number of nodes to reach a desired replication level of three, is three.

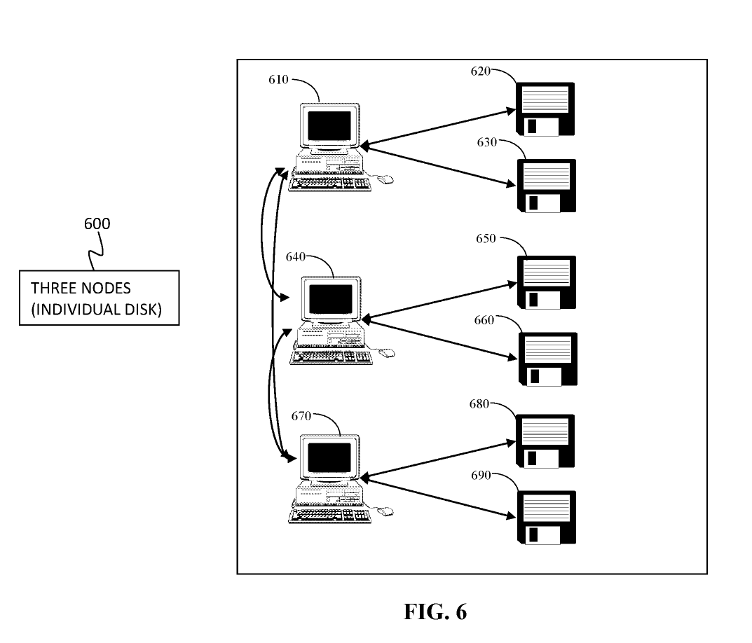

Referring now specifically to FIG. 6, a schematic diagram of a three or more node system 600 comprising computer storage nodes 610, 640 and 670 is shown. Computer storage node 610 has two storage disks 620 and 630. Likewise, the other computer storage nodes 640 and 670 each have two storage disks 650, 660, 680 and 690, respectively as show in the figure. Here however, when the third node joins the cluster, each node is treated as a single unit, as redundancy is guaranteed with the other nodes in the cluster. At the same time, the mirror configuration is broken apart on the first two nodes and all disks function as single units.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for implementing optimized data replication across cloud storage nodes, the system comprising:
a cluster of computer system devices;
one or more memory devices, comprised in one or more computer system devices of the cluster of computer system devices, wherein each memory device among the one or more memory devices stores:
a set of program modules;
a plurality of processors, a processor among the plurality of processor being comprised in a computer system device of the cluster of computer system devices, wherein at least one processor executes the set of program modules, the set of program modules comprising:
an input module, executed by the at least one processor, configured to:
receive a first instruction to add a first computer system device to the cluster, wherein the first computer system device comprises a first memory device; and
a data transfer module, executed by the processor, configured to copy data in at least one memory device in the cluster of computer system devices, to the first memory device, based on number of computer system devices in the cluster being lesser than a predefined number.

2. The system of claim 1, wherein the input module receives the first instruction from at least one of a user and at least one computer system device in the cluster.

3. The system of claim 1, wherein data in the at least one memory device is at least one of images, videos, documents, computer instructions, and databases.

4. The system of claim 1, wherein each computer system device in the cluster of computer system device is at least one of a laptop, a server, a network hardware device, a personal computer, and a smart phone, or any combination thereof.

5. The system of claim 1, wherein each computer system device in the cluster of computer system device is connected to each other via a network.

6. The system of claim 1, wherein the network is at least one of Bluetooth, WI-FI, mobile networks, and a WiMax network.

7. A method of implementing optimized data replication across cloud storage nodes, the method comprising:
receiving by at least one processor via an input module, a first instruction to add a first computer system device to the cluster, wherein the first computer system device comprises a first memory device; and
copying by the at least one processor via a data transfer module, data in at least one memory device in the cluster of computer system devices, to the first memory device, based on number of computer system devices in the cluster being lesser than a predefined number.

8. The method of claim 7, wherein the input module receives the first instruction from at least one of a user and at least one computer system device in the cluster.

9. The method of claim 7, wherein data in the at least one memory device is at least one of images, videos, documents, computer instructions, and databases.

10. The method of claim 7, wherein each computer system device in the cluster of computer system device is at least one of a laptop, a server, a network hardware device, a personal computer, and a smart phone, or any combination thereof.

11. The method of claim 7, wherein each computer system device in the cluster of computer system device is connected to each other via a network.

12. The method of claim 7, wherein the network is at least one of Bluetooth, WI-FI, mobile networks, and a WiMax network.
